(19) United States
(12) Patent Application Publication
(10) Pub. No.: US 2008/0251332 A1
(43) Pub. Date: Oct. 16, 2008

(54) ANTI-BLAST AND SHOCK REDUCTION BUFFER

(76) Inventors: James H. Stuhmiller, Rancho Santa Fe, CA (US); Philemon Chan, San Diego, CA (US)

Correspondence Address: NYDEGGER & ASSOCIATES, 348 OLIVE STREET, SAN DIEGO, CA, 92103, US

(21) Appl. No.: 12/101,846

(22) Filed: Apr. 11, 2008

Related U.S. Application Data
(63) Continuation-in-part of application No. 11/735,340, filed on Apr. 13, 2007.

(51) Int. Cl. F16F 9/36

(52) U.S. Cl. 188/322.16

(57) ABSTRACT

A device for mitigating shock loads utilizes load-fitted and form-fitted fluid capsules. Each capsule includes a pair of substantially flat end caps. Further, the end caps are parallel and are centered on a common axis. In each fluid capsule, high-tension members interconnect the two end caps to limit the axial distance between the end caps to less than a predetermined value. For each capsule, a membrane interconnects the peripheries of the end caps to enclose the fluid capsule between the end caps. Also, each fluid capsule includes a valve through the membrane to allow fluid flow between fluid capsules when a pressure on the valve exceeds a predetermined level. When a force is applied against a fluid capsule, the membrane deforms before fluid flows from the capsule to mitigate shock loading.

This application is a continuation-in-part of application Ser. No. 11/735,340 filed Apr. 13, 2007, which is currently pending. The contents of application Ser. No. 11/735,340 are incorporated herein by reference.

### FIELD OF THE INVENTION

The present invention pertains generally to systems for mitigating shock loads resulting from the rapid application of a force for a short duration of time. More particularly, the present invention pertains to fluid capsules for use in protective devices to mitigate the adverse effects that can result from shock loads. The present invention is particularly, but not exclusively, useful as a protective fluid capsule that incorporates predetermined membrane deformation and fluid transfer techniques to mitigate the injury effects of shock loadings.

### BACKGROUND OF THE INVENTION

A primary objective of any protective gear is to somehow mitigate the adverse effects that shock loading can have on the body. Low level impacts to the head can produce mild Traumatic Brain Injury (mTBI), while high level impacts to the head can produce massive internal injury and death. Impacts to the torso can produce lung contusion, pneumothorax (collapsed lung), heart contusion, and rupture of internal organs. Impacts to the extremities can lead to traumatic amputation.

In a combat environment, head protection is particularly important and is underscored by the fact fifty-nine percent of blast-injured patients develop some form of brain injury. These brain injuries are, unfortunately, in addition to other injuries that may also be sustained. Similar brain injuries can occur in sports. Analyses of helmet impacts in football have produced data that indicate that an acceleration of 106 g's is estimated to produce mTBI, 80% of the time, while an acceleration of 66 g's is estimated to produce mTBI 25% of the time.

Extrapolation of these data leads to the conclusion that accelerations must be less than 50 g's to be safe. It is the objective of effective head gear to transmit the impact force in such a way as to minimize the head acceleration.

Impact to the torso can produce significant internal injury. Even when the person is wearing personal body armor (military or law enforcement) that provides protection from the penetration of bullets and fragments, blunt trauma can occur from the inward deformation of the armor. Currently, armor designs are limited by these deformations. Research shows that these injuries are caused by the very short time duration that the impact is delivered to the body. It has been estimated that if the chest wall is accelerated to an inward velocity of 20-30 m/s, even for a very short time which produces a very small deformation, death can occur. Smaller chest velocities produce lesser forms of injury. Although an absolutely safe level has not been established, it is probably less than 8 m/s. The body can withstand, without injury, greater deformation if it is applied over a long period of time. It is the objective of effective body protection gear to transmit the impulse of the impact force in such a way as to maximize the duration of the impulse delivered to the torso and, therefore, minimize the chest wall velocity.

To put this in proper perspective, survivable explosions from an IED might produce blast loading with durations from less than one millisecond to as much as 10 milliseconds. The impact from the deformation of body armor has a duration ranging from less than one millisecond to a few milliseconds. The impact of helmets in sports or in a motorcycle accident is, again, only a few milliseconds. Mitigation of a shock loading is done typically by positioning a protective system between the impact source and the body part that is to be protected. The protective system must, therefore, act extremely quickly to distribute the impact force and duration over the largest area and largest duration to achieve the greatest effectiveness.

The efficacy of the protective system depends on several different factors, the more important of which include: 1) material characteristics of the protective body; 2) structural configuration of the protective body; and 3) attributes of the applied impact force. Of these, only the first two factors (material characteristics and configuration) can be controlled; the attributes of the applied impact force depend on the application. The concern of the present invention is toward the design of protective systems to protect the head, torso, and extremities from shock loading, that is, from large loads that occur with short time durations. These protective systems are judged on their ability to lower head acceleration, chest velocity, and other correlates of internal injury. Further, the present invention can further be used to protect inanimate objects from shock loading.

Open and closed cell foam or liquid or gas-liquid gels are commonly used as fluid cushioning material in headgear or behind body armor or in shoes. These materials, especially the foams, are designed to provide a certain crushing load when stressed at a certain rate. Although these materials may be efficacious for some types of force loadings, they do not provide the theoretical optimum protection possible and have characteristics that lose their cushioning ability for short duration loading. For the shock loading of interest, other materials, with an appropriate structural configuration, are more effective.

In light of the above, it is an object of the present invention to provide a fluid capsule device for mitigating shock loads on a human body that incorporates the dynamic properties of fluid density and compression, membrane characteristics and response, and fluid motion and exchange. Another object of the present invention is to provide a Fast Acting Vented Optimal Reducer (FAVOR) for mitigating shock loading. Another object of the present invention is to provide a fluid capsule for mitigating shock loads that can be specifically configured (i.e. customized) to conform with different types of body regions (headgear, body armor, shoes, etc.) and to respond to different shock loading magnitudes and rates, for different applications. Still another object of the present invention is to provide a fluid capsule that has a predetermined height and predetermined geometric deformation to mitigate shock loading. Another object of the present invention is to provide a fluid capsule device that effectively regulates fluid pressure through venting and capsule geometry control. Yet another object of the present invention is to provide a fluid capsule device for mitigating shock loads that is relatively simple to manufacture, simple to use, and comparatively cost effective.

### SUMMARY OF THE INVENTION

In accordance with the present invention, a device for mitigating the adverse effects of shock loading employs a load-fitted and form-fitted fluid capsule. Specifically, fluid capsules are designed and fabricated for fast delivery of cushion load and effective regulation of the intra-capsule fluid pressure through venting and capsule geometry control. These capsules may be used in all impulsive loading applications, such as shock, blunt, and ballistic impacts.

Structurally, each fluid capsule defines a principal axis and includes a pair of substantially flat end caps centered on, and perpendicular to, the axis. Preferably, the end caps have identical peripheries that bound interior areas of the end caps. Further, an elastic membrane interconnects the peripheries of the end caps to enclose the capsule. Also, the device provides a plurality of axially-extending high-tension members that interconnect the end caps. Preferably, the high-tension members are strings or strips. As a result of the axially-extending high-tension members, the axial distance between the end caps is limited to less than a predetermined value. Further, due to the inelasticity of the high-tension members, the members provide geometric control over deformation of the elastic membrane during shock loading to regulate fluid flow and improve performance of the fluid capsule.

In certain embodiments, the high-tension members may interconnect the peripheries of the end caps, the interior areas of the end caps, or both the peripheries of the end caps and the interior areas of the end caps. Further, in certain embodiments, the membrane may include opposing planar side walls which are interconnected by high-tension members that are perpendicular to lines parallel to the axis. In other embodiments, high-tension members may circumscribe the membrane on planes perpendicular to the axis.

In addition to cushioning shock loading through membrane deformation, the present device regulates fluid pressure by venting fluid from a fluid capsule under a load. For this reason, each fluid capsule includes at least one vent in the membrane. Further, a valve is imbedded in each vent to establish a predetermined fluid flow through the respective vent. Specifically, each valve opens to allow fluid flow from the fluid capsule when a pressure in the fluid capsule exceeds a predetermined level. In order to optimize performance of each capsule, the fluid pressure in each capsule may be initially set within 10% of the predetermined level.

For a preferred embodiment of the present invention, a plurality of fluid capsules are interconnected and arranged in a matrix. In this embodiment, each capsule may have an individually selected size and geometry so that an optimal number of capsules may be used. Further, the arrangement of high-tension members for each fluid capsule may be individualized. Specifically, the predetermined value for the maximum axial distance may be independently selected for each capsule. Also, the valves in each capsule may be designed with individually optimized predetermined venting pressure levels. Moreover, each capsule may be pre-pressurized to a desired percentage of the its valves' venting pressure level. As a result, each fluid capsule can be tuned to provide a desired performance in conjunction with the other fluid capsules.

Through the use of substantially flat end caps, the contract area between a fluid capsule and an external challenge, i.e., an impact force, is maximized. When comparing a fluid capsule with flat end caps to a spherical bubble, it may be seen that the ends of the fluid capsule have a far greater contact area than the ends of the sphere. As a result, the transfer of force from an external challenge to the fluid capsule may occur more quickly and efficiently than the transfer of a force to the spherical bubble. Further, the high-tension members provide a controlled position for the end caps by limiting the axial distance between the end caps to a predetermined value. With pre-pressurization of the fluid capsule, the end caps are separated by the maximum value axial distance. Therefore, the geometry of the fluid capsule is predetermined, and the capsule provides a predictable and repeatable behavior in response to an impact force. With the described structure, the fluid capsule provides fast load mitigation.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of a protective fluid capsule in accordance with the present invention;

FIG. 2 is a perspective view of the fluid capsule of FIG. 1 after deformation due to shock loading;

FIG. 3A is a perspective view of an alternate fluid capsule for use in the present invention;

FIG. 3B is a perspective view of the fluid capsule of FIG. 3A during shock loading;

FIG. 4A is a perspective view of another alternate fluid capsule for use in the present invention;

FIG. 4B is a cross-sectional view of the fluid capsule of FIG. 4A, taken along line 4-4 in FIG. 4A.

FIG. 4C is a cross-sectional view of an alternate fluid capsule;

FIG. 5 is a perspective schematic view of a protective fluid capsule in accordance with the present invention, with the fluid capsule shown having a fluid transfer system incorporated into a helmet for use as a head protector;

FIG. 6 is a view of the fluid capsule as seen along the line 6-6 in FIG. 5 with portions of the helmet removed for clarity;

FIG. 7A is a cross section view of a portion of the fluid capsule as seen along the line 7-7 in FIG. 6 before a blast impact; and

FIG. 7B is a view of the fluid capsule as seen in FIG. 7A after a blast impact.

### DESCRIPTION OF THE PREFERRED EMBODIMENTS

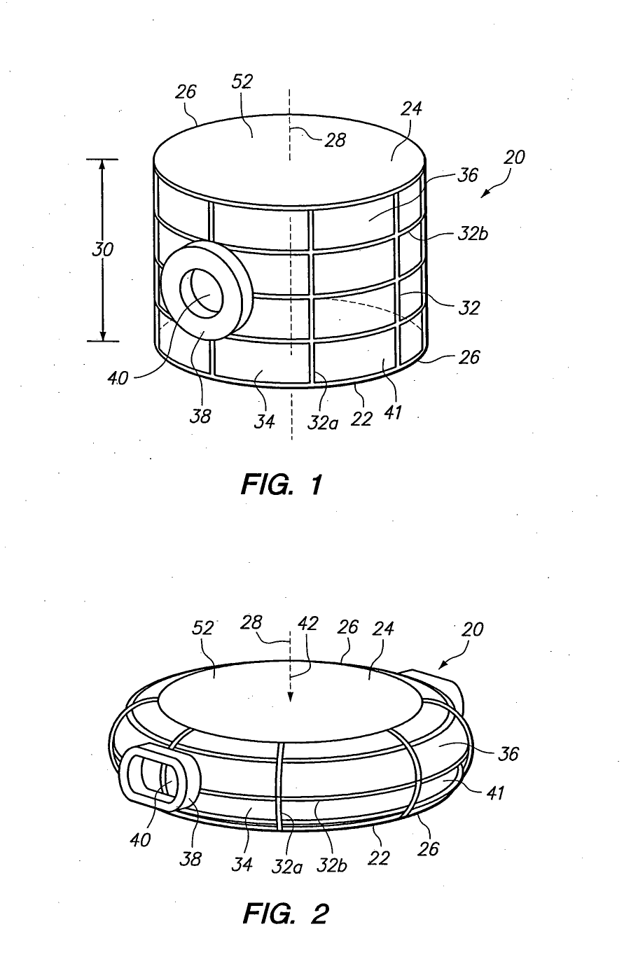

Referring to FIG. 1, a device for mitigating shock loads in accordance with the present invention is shown and is generally designated 20. As shown, the device 20 includes a first end cap 22 and a second end cap 24. In FIG. 1, each end cap 22, 24 is substantially flat and has a circular periphery 26. Structurally, the end caps 22, 24 are formed from relatively firm materials with adequate bending stiffness, such as thin aluminum plates, plastics or composites. Further, each end cap 22, 24 is centered on, and perpendicular to, an axis 28 defined by the device 20. Also, the first end cap 22 is distanced from the second end cap 24 by an axial distance 30.

As shown in FIG. 1, the device 20 includes a plurality of high-tension members 32. Specifically, a plurality of axially-extending high-tension strings 32a are azimuthally spaced about the peripheries 26 and interconnect the first end cap 22 to the second end cap 24. Because the high-tension strings 32a are substantially non-elastic, they limit the axial distance 30 between the end caps 22, 24 to a maximum pre-determined value. Preferably, the high-tension strings 32 are formed from nylon, Kevlar, or a similar material with very high tensile strength and negligible bending resistance. In FIG. 1, it can be seen that the device 20 also includes circumferentially-extending high-tension strings 32b. As shown, the high-tension strings 32b circumscribe the device 20 and are substantially coplanar or parallel to the end caps 22, 24. In certain embodiments the high-tension strings 32b are inelastic and identical to the high-tension strings 32b. In FIG. 1, however, the circumferential high-tension strings 32b are somewhat elastic to allow for a desired geometric deformation under shock-loading. Importantly, the elasticity of the high-tension strings 32a, 32b are controllable and predetermined to provide for the desired behavior under shock-loading.

In addition to the end caps 22, 24 and high-tension strings 32, the device 20 includes a thin elastic membrane 34. As shown, the membrane 34 is bonded to the periphery 26 of the first end cap 22 and the periphery 26 of the second end cap 24. As a result, the membrane 34 and end caps 22, 24 cooperate to established an enclosed fluid capsule 36. Also, the device 20 includes vents 38 positioned on the membrane 34 to provide fluid flow into and out of the fluid capsule 36. Each vent 38 has a valve 40 made of soft elastomeric material to open when compressed by a predetermined level of fluid pressure. As shown, the high-tension strings 32 may be embedded in the membrane 34.

During construction, the device 20 may be formed as a unibody structure, or the membrane 34 may be formed as a bubble that is sandwiched and pressurized between the end caps 22, 24. As shown in FIG. 1, the fluid capsule 36 is filled with a fluid 41 to an initial pressure that is less than the predetermined level of fluid pressure. As a result of the initial pressure, the axial distance 30 between the end caps 22, 24 is at its maximum pre-determined value. Typically, the device 20 is prepared as shown in FIG. 1 to cushion against an external shock in the direction of the axis 28.

In FIG. 2, the device 20 is shown after an external shock on the second end cap 24 in the direction of arrow 42 representing the axial component of a force. As shown, the axial distance 30 between the first end cap 22 and the second end cap 24 is significantly reduced from the maximum pre-determined value as the fluid capsule 36 is compressed. During compression of the fluid capsule 36, the membrane 34 is deformed by expanding. Also, the high-tension members 32b elongate in response to the external shock and compression of the capsule 36. When the fluid pressure in the fluid capsule 36 reaches the predetermined value, the valve 40 opens. As a result, fluid 41 flows through the valve 40 out of the fluid capsule 36.

As may be understood from FIGS. 1 and 2, the high-tension members 32 provide geometric control of membrane deformation in response to shock loading. As noted, the high-tension members 32a, 32b may be selected to have different elastic behavior under varying forces. Further, the valves 40 provide venting of the fluid capsule 36 when the predetermined value of pressure is reached. As a result, the fluid capsule 36 exhibits fast delivery of cushion load followed by effective regulation of fluid pressure.

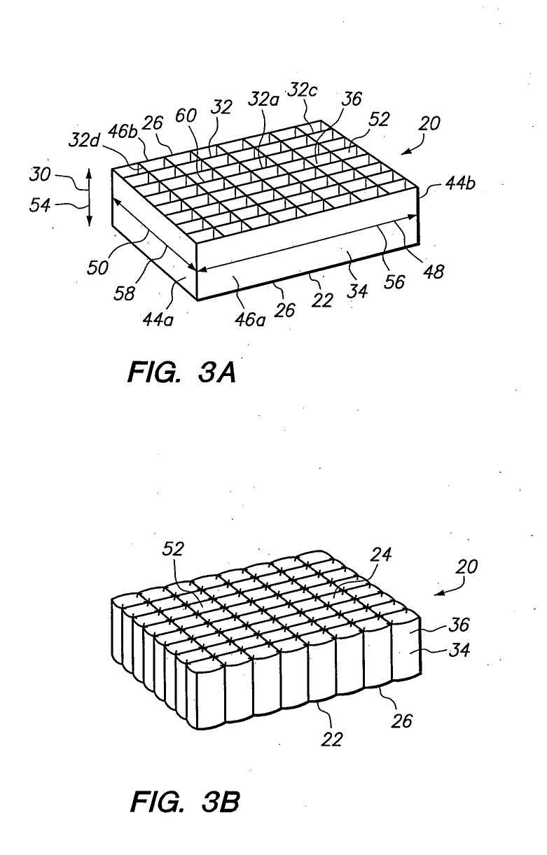

Referring now to FIG. 3A, an alternate embodiment of the device 20 for mitigating shock loads is shown. In FIG. 3A, the second end cap 24 has been removed to provide a view of the internal components of the device 20. As may be understood, the first end cap 22 and second end cap 24 have rectangular peripheries 26. Accordingly, the membrane 34 includes a first pair of opposing side walls 44a, 44b, and a second pair of opposing side walls 46a, 46b. As shown, the opposite side walls 44a, 44b are separated by a distance 48 and the opposite side walls 46a, 46b are separated by a distance 50. Also, the periphery 26 of each end cap 22, 24 can be said to bound an interior area 52.

Still referring to FIG. 3A, the high-tension members 32 are shown to be fabric strips that have a height 54 substantially equal to the maximum predetermined value of the axial distance 30 between the end caps 22, 24. Further, the high-tension members 32c interconnect the opposite side walls 44a, 44b and have a length 56 equal to the distance 48. Likewise, the high-tension members 32d interconnect the opposite side walls 46a, 46b and have a length 58 equal to the distance 50. As shown, the high-tension members 32c and 32d intersect at interfaces 60 that extend from the interior area 52 of the first end cap 22 to the interior area 52 of the second end cap 24.

Referring now to FIG. 3B, the device 20 of FIG. 3A is shown after an external shock is applied to the device 20. In FIG. 3A, the high-tension members 32a, 32c, 32d are all substantially inelastic. As shown, the membrane 34 deforms by expanding in areas not directly connected to high-tension members 32. While not shown, it is understood that the device 20 of FIGS. 3A and 3B includes vents 38 with valves 40 which allows the fluid 41 to exit the fluid capsule 36 when the internal fluid pressure reaches the predetermined level of pressure to open the valves 40.

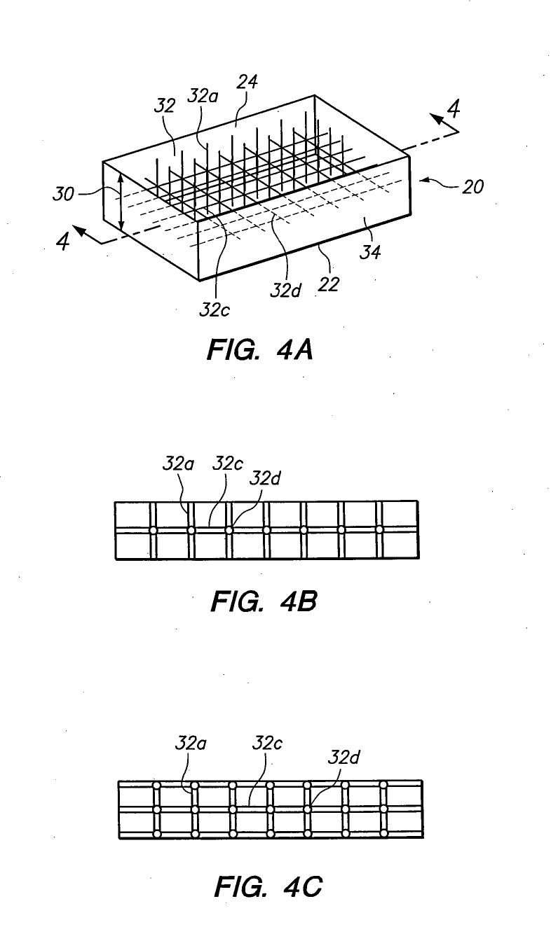

Referring to FIG. 4A, another embodiment of the device 20 is illustrated. In FIG. 4A, the end caps 22, 24 and membrane 34 are substantially the same as in FIGS. 3A and 3B. As can be seen, the high-tension members 32, while inelastic, are of a different construction from that in FIGS. 3A and 3B. Specifically, the members 32 are strings and do not have a height equal to the maximum predetermined value of the axial distance 30 between the end caps 22, 24. Instead, axially-extending high-tension strings 32a are positioned at the intersection of the high-tension strings 32c and 32d. This construction may be more easily understood from FIG. 4B, which is a cross-sectional view of FIG. 4A taken along line 4-4. As may be understood from FIG. 4B, a single axially-extending high-tension string 32a is intersected only by one high-tension string 32c and by one high-tension string 32d. On the other hand, in the alternate embodiment shown in FIG. 4C, each axially-extending high-tension string 32a is intersected only by three parallel high-tension strings 32c and by three parallel high-tension strings 32d.

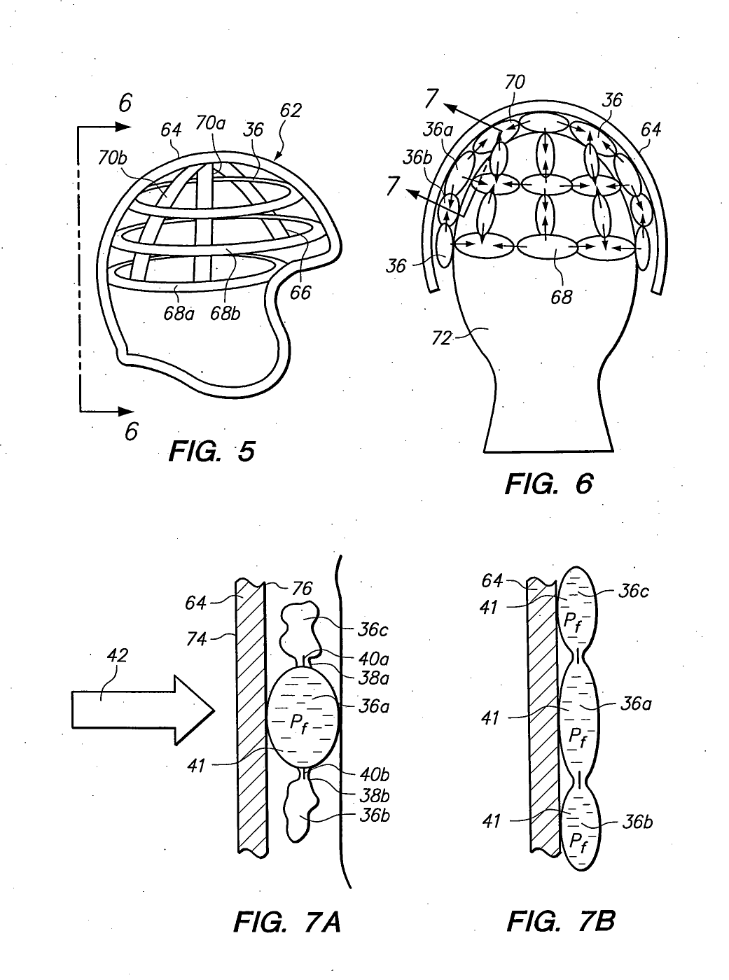

Referring to FIG. 5, a system for mitigating blast impacts in accordance with the present invention is shown and is generally designated 62. As shown, the system 62 includes a plurality of fluid capsules 36 that has been incorporated as part of a helmet 64 to provide head protection. More specifically, for the embodiment of the present invention shown in FIG. 5, the fluid capsules 36 are configured in a matrix 66 having a plurality of rings 68, of which the rings 68a and 68b are exemplary. The matrix 66 is also shown to have a plurality of strips 70, of which the strips 70a and 70b are exemplary. As will be appreciated by the skilled artisan, the rings 68 and strips 70 can be used together, in combination, or individually.

Referring now to FIG. 6, the rings 68 and strips 70 of the system 62 are shown, in detail, to include a plurality of interconnected fluid capsules 36. The fluid capsules 36 that are shown are only exemplary, and fluid capsules 36 having varying geometries and pressures may be employed. FIG. 6 also shows that the fluid capsules 36 are positioned inside the helmet 64 to protect the head 72 of a user. This also is exemplary. Although the fluid capsule 36 shown in FIG. 6 is being used for protection of a head 72, it is to be understood that fluid capsules 36 can be uniquely configured and used for protection of other body parts, such as the torso, legs, arms and neck.

FIGS. 7A and 7B best show the structural and functional interaction between connected fluid capsules 36a, 36b and 36c. In FIGS. 7A and 7B, the geometry and fluid pressurization illustrated are merely exemplary. Preferably, the fluid capsules 36 will be similar in construction and initial pressurization to those shown in FIGS. 1, 3A, and 4A. In FIG. 7A, the fluid capsule 36a is shown to be filled with a fluid 41 having an initial fluid pressure “pf”. Further, FIG. 7A shows that a vent 38a is provided to establish fluid communication between the fluid capsule 36a and the adjacent fluid capsule 36b. Also, a valve 40a is shown imbedded into the vent 38a. Similarly, a vent 38b, in combination with a valve 40b, is provided to establish fluid communication between the fluid capsule 36a and the adjacent fluid capsule 36c. As intended for the present invention, the system 62 will include numerous such fluid connections throughout its matrix 66. As implied above, the actual number and placement of the rings 68 and strips 70 is a matter of design choice.

In the event of a blast (shock loading or a blunt force impact), indicated by the arrow 42 in FIG. 7A, the helmet 64 will act as a plate member having an impact surface 74 and a force transfer surface 76. Structurally, the helmet 64 will transfer the effect of the blast 42 to the fluid capsule 36a. For fluid capsule 36a, the result will be an increase in pressure (pf) on fluid 41 in the fluid capsule 36a. Additional fluid capsules 36 will, of course, also be affected. And, each fluid capsule 36 will respond substantially the same as described here for the fluid capsule 36a.

Functionally, due to the increased pressure on the fluid 41 in the fluid capsule 36a, in response to the blast 42, the membrane 34 will deform as indicated in FIGS. 2 and 3B. When the pressure on the fluid 41 reaches the predetermined level, the valves 40a and 40b will open. This permits fluid 41 to flow from fluid capsule 36a into the adjacent fluid capsules 36b, 36c through respective vents 38a and 38b. Consequently, as shown in FIG. 7B, the fluid capsules 36b, 36c fill with fluid 41. As the fluid capsules 36b, 36c fill with fluid 41, a pressure “pr” is established on the fluid 41 in the fluid capsules 36b, 36c. As intended for the present invention, this transfer of the fluid 41 from the fluid capsule 36a into the fluid capsules 36b, 36c mitigates the adverse effects of the blast 42 on the head 72. If the valves 40a and 40b are one-way valves, the fluid capsule 36 will remain in the configuration shown in FIG. 7B after the effects have subsided. In this case, pr will, most likely, equal pf. On the other hand, if the valves 40a and 40b are two-way valves, fluid 41 can back flow from the fluid capsules 36b, 36c into fluid capsule 36a, as long as “pr” is greater than “pf”.

As indicated above, the fluid transfer system described above with reference to FIGS. 6, 7A and 7B is but one embodiment envisioned for the present invention. Other systems are envisioned. Furthermore, it is to be appreciated that elements of one system can be incorporated into another. The result is that fluid capsules 36 can be individually customized for the system 62. For this purpose, the specifics of a fluid capsule 36 for the system 62 will be determined, in large part, by the particular application. With this in mind, several structural variations for fluid systems that can be incorporated into a fluid capsule 36 are envisioned for the present invention. In particular, each fluid capsule 36 may include a different peripheral shape, a different maximum axial distance between end caps, and a different predetermined level of pressure for venting. Further, each fluid capsule 36 may be pre-pressurized differently. For best performance, it is preferred that the capsules are pressurized to within 10% of the capsule's predetermined pressure value. Also, each fluid capsule 36 may include a different arrangement of high-tension members 32 for controlling deformation of the capsule's membrane 34.

For all embodiments of the fluid systems disclosed above, the present invention envisions a mitigation of the forces imposed by a shock loading 42 against a human body. Specifically, the energy that is absorbed by the fluid capsule 36, after an impact from blast 42, is used to deform the membrane 34 and in the fluid transfer process. For purposes of the present invention, as mentioned numerous times herein, the particular embodiment of the fluid system that is used for construction of the fluid capsule 36, and its configuration, are primarily design considerations. Further, although the specific materials used for construction of the membrane 34 can be varied, the use of a semicrystalline polymer, such as polyurethane-PU or polyethylene-PE, is recommended.

For all embodiments of the fluid systems disclosed above, the present invention envisions the controlled deformation of the membrane of a fluid capsule to mitigate shock loading. Further, all embodiments consider a transfer of fluid within or between fluid capsules to regulate fluid pressure after membrane deformation.

While the particular Anti-Blast and Shock Reduction Buffer as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A device for mitigating shock loads which comprises:
a first end cap, wherein the first end cap is substantially flat and has a periphery, and wherein the first end cap defines an axis substantially perpendicular thereto;
a second end cap, wherein the second end cap is substantially flat, has a periphery and is oriented on the axis substantially parallel to the first end cap;
a plurality of high-tension members interconnecting the first end cap with the second end cap to limit an axial distance between the first end cap and the second end cap to less than a predetermined value; and
a membrane interconnecting the periphery of the first end cap with the periphery of the second end cap to create an enclosed fluid capsule between the first and second end caps, wherein the membrane is deformable to mitigate shock loading in response to an axial component of a force applied against the device.

2. A device as recited in claim 1 wherein the high-tension members interconnect the periphery of the first end cap with the periphery of the second end cap.

3. A device as recited in claim 1 wherein the periphery of each end cap defines an interior area for each end cap, and wherein the high-tension members interconnect the interior area of the first end cap with the interior area of the second end cap.

4. A device as recited in claim 1 further comprising a plurality of high-tension members circumscribing the membrane to control deformation of the membrane.

5. A device as recited in claim 1 wherein the membrane includes four side walls, with each side wall being opposite another side wall, and wherein the device further comprises at least one high-tension string interconnecting each side wall to the respective opposite side wall.

6. A device as recited in claim 5 wherein each high-tension string has a height equal to the axial distance between the first end cap and the second end cap, and wherein each high-tension string has a length equal to a distance between opposite side walls.

7. A device as recited in claim 1 further comprising:
at least one vent formed in the fluid capsule by the membrane; and
a valve imbedded in the vent to establish a predetermined fluid flow therethrough.

8. A device as recited in claim 1 further comprising at least one vent formed in the fluid capsule by the membrane, wherein the vent is rupturable for a one-time use of the device.

9. A device as recited in claim 1 further comprising at least one valve formed in the fluid capsule by the membrane, wherein the valve opens to allow fluid flow from the fluid capsule when a pressure in the fluid capsule exceeds a predetermined level.

10. A device as recited in claim 9 wherein the fluid capsule is pre-pressurized to an initial pressure within 10% of the predetermined level.

11. A system for mitigating shock loads which comprises a plurality of fluid capsules in fluid communication with one another, wherein each fluid capsule comprises:
a first end cap, wherein the first end cap is substantially flat and has a periphery, and wherein the first end cap defines an axis substantially perpendicular thereto;
a second end cap, wherein the second end cap is substantially flat, has a periphery and is oriented on the axis substantially parallel to the first end cap;
a plurality of high-tension members interconnecting the first end cap with the second end cap to limit an axial distance between the first end cap and the second end cap to less than a predetermined value; and
a membrane interconnecting the periphery of the first end cap with the periphery of the second end cap to enclose the respective fluid capsule between the first and second end caps, wherein the membrane is deformable to mitigate shock loading in response to an axial component of a force applied against the system.

12. A system as recited in claim 11 wherein each fluid capsule further comprises a plurality of high-tension members circumscribing the membrane to control deformation of the membrane.

13. A system as recited in claim 11 wherein, for each fluid capsule, the membrane includes four side walls, with each side wall being opposite another side wall, and wherein each fluid capsule further comprises at least one high-tension string interconnecting each side wall to the respective opposite side wall.

14. A system as recited in claim 13 wherein, for each fluid capsule, each high-tension string has a height equal to the axial distance between the first end cap and the second end cap, and wherein each high-tension string has a length equal to a distance between opposite side walls.

15. A system as recited in claim 11 wherein each fluid capsule further comprises:
at least one vent formed in the fluid capsule by the membrane; and
a valve imbedded in the vent to establish a predetermined fluid flow therethrough.

16. A system as recited in claim 11 further comprising at least one vent formed in the fluid capsule by the membrane, wherein the valve opens to allow fluid flow from a respective fluid capsule to another fluid capsule when a pressure in the respective fluid capsule exceeds a predetermined level.

17. A system as recited in claim 11 wherein selected fluid capsules are pre-pressurized to initial pressures within 10% of the respective predetermined level.

18. A method for mitigating shock loads at a location which comprises the steps of:
preparing a plurality of fluid capsules, wherein each fluid capsule comprises (a) a first end cap, wherein the first end cap is substantially flat and has a periphery, and wherein the first end cap defines an axis substantially perpendicular thereto, (b) a second end cap, wherein the second end cap is substantially flat, has a periphery and is oriented on the axis substantially parallel to the first end cap, (c) a plurality of high-tension members interconnecting the first end cap with the second end cap to limit an axial distance between the first end cap and the second end cap to less than a predetermined value, and (d) a membrane interconnecting the periphery of the first end cap with the periphery of the second end cap to enclose the respective fluid capsule between the first and second end caps;
positioning the fluid capsules in the location;
establishing fluid communication between the plurality of fluid capsules; and
pre-pressurizing each fluid capsule to a selected fluid pressure, wherein, the membrane of each fluid capsule is deformable to mitigate shock loading in response to an axial component of a force applied against the fluid capsules.

19. A method as recited in claim 18 wherein each fluid capsule further comprises at least one valve for fluid communication with other fluid capsules, wherein each valve opens to allow fluid flow between fluid capsules when a pressure on the valve exceeds a predetermined level.

20. A method as recited in claim 19 further comprising the step of tuning each fluid capsule by selecting the predetermined value for the axial distance between the first end cap and the second end cap and by selecting the predetermined level for each valve.
